(19) United States
(12) Patent Application Publication
(10) Pub. No.: US 2026/0302623 A1
(43) Pub. Date: Oct. 1, 2026

(54) Multi-Layer Antenna

(71) Applicant: Apple Inc., Cupertino, CA (US)

(72) Inventors: Yanfeng Chen, San Ramon, CA (US); Shankar S. Pennathur, San Jose, CA (US); Divya Choudhary, San Francisco, CA (US); Sheng Kong, Shanghai (CN); Zhiqi Wang, Suzhou (CN); Mandar S. Painaik, Chandler, AZ (US); Amir Salehi, Carmel by the Sea, CA (US); Amogh Ashok Zadbuke, Fremont, CA (US); Jerzy S. Guterman, Sunnyvale, CA (US); Jue Wang, San Jose, CA (US); Leif Henrik Johansson, Hjarup (SE)

(21) Appl. No.: 19/094,299

(22) Filed: Mar. 28, 2025

(51) Int. Cl. H01Q 9/04

(52) U.S. Cl. CPC H01Q 9/0414

(57) ABSTRACT

Electronic modules that include an antenna are described in accordance with embodiments. In an embodiment, the antenna includes an adhesive insulation layer, a patterned metal antenna layer over the adhesive insulation layer, and a protective layer over the patterned metal antenna layer. Further, the adhesive insulation layer of the antenna may be attached to an integrated circuit (IC) package structure, where the IC package structure may include an electronic component bonded to a routing layer and a gap fill material that encapsulates the electronic component. In such instances, the patterned metal antenna layer of the antenna may be electrically connected to the routing layer.

### BACKGROUND

### Field

Embodiments described herein relate to semiconductor packaging, more particularly to antennas.

### Background Information

The ecosystem of wireless communication depends on several key protocols and technologies, such as Bluetooth, Wi-Fi, near field communication, LTE, 5G, etc. Antennas play a key role in implementing such protocols and technologies. For example, antennas can convert alternating electric current into radio waves (e.g., transmission) and, conversely, convert radio waves into electric current (e.g., reception) to enable communication between devices. For transmission, a transmitter supplies an electric current to the antenna's terminals and the antenna radiates the energy from the current as electromagnetic waves. For reception, an antenna intercepts some of the power of a radio wave to produce an electric current at its terminals, where the electric current is applied to a receiver to be amplified. Further, the current market demand for devices with higher component density at a smaller volume has driven the need for more compact components (including antennas) with higher antenna efficiency at a reduced size, better reliability, and lower cost.

### SUMMARY

Embodiments describe electronic modules that include an antenna attached to an integrated circuit (IC) package structure or advanced IC package structure such as Ball Grid Array (BGA), Wafer Level Package (WLP), System-in-Package (SiP), Multi-Chip Module (MCM), Package on Package (PoP), and 2.5 & 3D IC Package, where the IC package structure may include an electronic component (e.g., IC die, multiple IC dies with passives, packages, etc.) bonded to a routing layer and a gap fill layer that encapsulates these components. Further, the IC package structure may be mounted to a module substrate (e.g., rigid printed circuit board (PCB), flexible printed circuit (“FPC”), etc.) and connected to other parts in a system by connectors, hot bars, etc. In such instances, the antenna may include an adhesive insulation layer that attaches to a surface (or multiple surfaces) of the IC package structure, a patterned metal antenna layer over the adhesive insulation layer, and a protective layer over the patterned metal antenna layer, where the patterned metal antenna layer electrically connects to the routing layer of the IC package structure. In some embodiments, the antenna may include multiple patterned metal antenna layers. For example, a first patterned metal antenna layer may include a first pattern, and a second patterned metal antenna layer may include a second pattern, where the first pattern and second pattern are connected and accordingly provide different functionalities or improved functionalities within the same antenna.

### BRIEF DESCRIPTION OF THE DRAWINGS

FIG. 1A is a cross-sectional side view illustration of an electronic module that includes an antenna attached to a top surface of an integrated circuit (IC) package structure in accordance with embodiments.

FIG. 1B is a cross-sectional side view illustration of an electronic module that includes an antenna attached to a bottom surface of an IC package structure in accordance with embodiments.

FIG. 1C is a cross-sectional side view illustration of an electronic module that includes an antenna attached to multiple surfaces of an IC package structure in accordance with embodiments.

FIG. 2A is a close-up view of an antenna that includes a through hole that extends through an entire thickness of the antenna in accordance with embodiments.

FIG. 2B is a close-up view of an antenna that includes a through hole that extends through a partial thickness of the antenna in accordance with embodiments.

FIG. 3A is a close-up view of an antenna that includes multiple patterned metal antenna layers in accordance with embodiments.

FIG. 3B is a top view of an antenna in accordance with embodiments.

### DETAILED DESCRIPTION

It has been observed that printed circuit board (“PCB”), flexible printed circuit (“FPC”) and laser direct structuring (“LDS”) antennas are some of the most widely used antenna types for consumer electronics. PCB antennas are typically used for devices such as Bluetooth modules, wi-fi modules, etc., where the manufacturing cycle can be long and changes to the design of the antenna can be very difficult to make. LDS antennas use a plating process to form the antenna pattern on an injection-molded plastic part, where the plating process can be expensive and may require special plating licenses to meet the environmental laws in many countries or regions. Further, the injection-molded plastic part of LDS antennas can have a large volume. FPC antennas are also widely used but they too can have a large footprint and often require additional connections (e.g., hot bars, etc.) that can be failure points.

In embodiments, an electronic module may include an antenna attached to an integrated circuit (“IC”) package structure, where the IC package structure may be mounted to a module substrate. The antenna may include an adhesive insulation layer to attach the antenna to a surface (or multiple surfaces) of the IC package structure, a patterned metal antenna layer over the adhesive insulation layer to serve as the functional antenna layer, and a protective layer over the patterned metal antenna layer to prevent oxidation, scratching, contamination, etc. In such instances, the patterned metal antenna layer may be fabricated (e.g., die cutting, laser cutting, etc.) from metal tapes, which has a lower cost and allows for a shorter lead-time than conventional devices. In addition, the footprint of the antenna is smaller than conventional devices so that multiple patterned metal antenna layers (each with different functionality) may be used in the same antenna stack-up to provide increased functionality within a smaller volume.

In various embodiments, description is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the embodiments. In other instances, well-known semiconductor processes and manufacturing techniques have not been described in particular detail in order to not unnecessarily obscure the embodiments. Reference throughout this specification to “one embodiment” means that a particular feature, structure, configuration, or characteristic described in connection with the embodiment is included in at least one embodiment. Thus, the appearances of the phrase “in one embodiment” in various places throughout this specification are not necessarily referring to the same embodiment. Furthermore, the particular features, structures, configurations, or characteristics may be combined in any suitable manner in one or more embodiments.

The terms “above”, “over”, “to”, “between”, and “on” as used herein may refer to a relative position of one layer with respect to other layers. One layer “above”, “over”, or “on” another layer or bonded “to” or in “contact” with another layer may be directly in contact with the other layer or may have one or more intervening layers. One layer “between” layers may be directly in contact with the layers or may have one or more intervening layers.

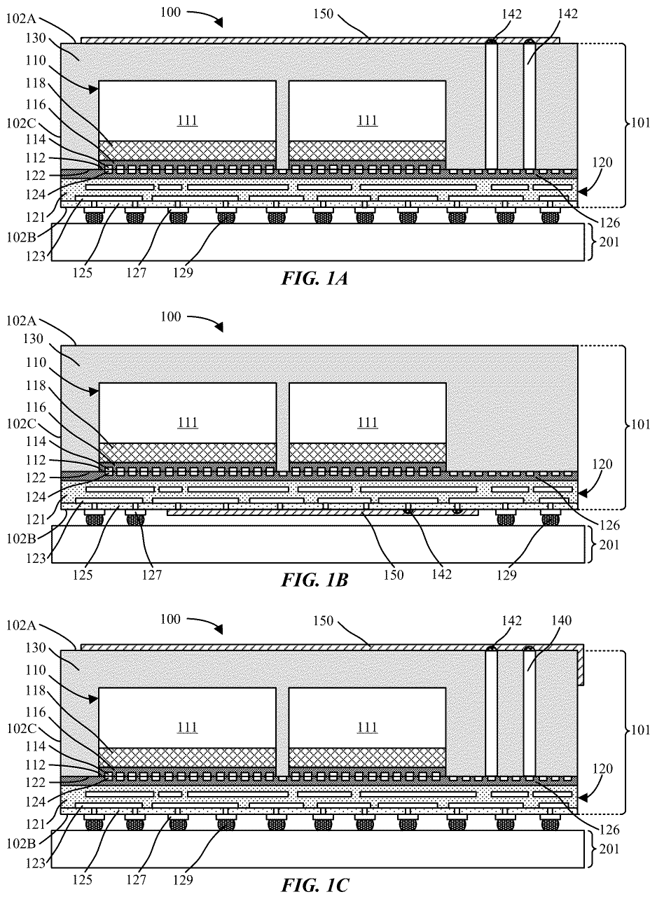

Referring now to FIGS. 1A-1C, FIG. 1A is a cross-sectional side view illustration of an electronic module that includes an antenna attached to a top surface of an integrated circuit (IC) package structure in accordance with embodiments; FIG. 1B is a cross-sectional side view illustration of an electronic module that includes an antenna attached to a bottom surface of an IC package structure in accordance with embodiments; FIG. 1C is a cross-sectional side view illustration of an electronic module that includes an antenna attached to multiple surfaces of an IC package structure in accordance with embodiments. As shown in FIGS. 1A-1C, electronic module 100 may include an IC package structure 101 mounted to a module substrate 201 (e.g., printed circuit board (PCB), etc.). Module substrate 201 may include dielectric layers with embedded copper traces that connect IC package structure 101 to other components within a device. The dielectric layers of module substrate 201 may include flame retardant laminates (e.g., FR4, high-Tg FR4, etc.) although other suitable dielectric materials may be utilized (e.g., polyimide, modified epoxy resins, etc.), where such dielectric layers may be designed to shorten electrical paths, minimize signal degradation, etc. (e.g., skip dielectric layers, etc.). Further, the embedded copper traces may be of varying heights or thicknesses (e.g., 3D copper), where such traces may be vertically higher as compared to standard traces. IC package structure 101 may include one or more electronic components 110 bonded to routing layer 120 by any suitable method (e.g., flip-chip bonding, hybrid bonding, surface mount technology (SMT), etc.), where electronic component 110 can be an integrated circuit die, a package (e.g., package-in-package (PiP)) or any combination thereof. Further, IC package structure 101 may also be connected to other parts inside a device by connectors, hot bars, etc. at bottom surface 102B. Alternatively, IC package structure 101 can be connected to other parts electrically inside a device by interposers through gap fill material 130 or connectors or hot bars on routing layer 120 outside of gap fill material 130. Various exemplary dies or packages may include system-on-chip (SOC), graphics processing unit (GPU), central processing unit (CPU), artificial intelligence (AI), machine learning logic, radio-frequency (RF) baseband processor, RF front end, signal processors, power management integrated circuit (PMIC), logic, memory, photonics, biochips, low speed and/or high speed input/output (HSIO), cache, a silicon interconnect, system-in-package (SiP) and any combinations thereof.

In further reference to FIGS. 1A-1C, electronic component 110 may include a semiconductor layer 111 and a back-end-of-the-line (BEOL) build up structure 118. The semiconductor layer 111 may be a bulk silicon substrate, silicon-on-insulator substrate, etc. and may have an epitaxial device layer over the bulk silicon. It should be noted that silicon is exemplary and that other semiconductor substrate materials may be used. The BEOL build-up structure 118 may include electrical routing as is customary, as well as metal sealing structures (e.g., seal rings) to provide mechanical integrity and function as a physical barrier to moisture and impurity ingress. In addition, electronic component 110 may be encapsulated by gap fill material 130. In some embodiments gap fill material 130 may include a molding compound (e.g., epoxy molding compound, etc.) to encapsulate the IC dies and/or packages, whereas in other embodiments gap fill material 130 may include other suitable material that may be deposited rather than molded to encapsulate the IC dies and/or packages (e.g., oxides, silicon, etc.).

In further reference to FIGS. 1A-1C, electronic component 110 may be bonded to routing layer 120. Routing layer 120 may be formed by a layer-by-layer process, and may be formed using thin film technology. Routing layer 120 may include one or more dielectric layers 121 and one or more redistribution lines 123. The one or more dielectric layers 121 may be formed by standard deposition techniques (e.g., lamination, spin coating, spray coating, physical vapor deposition, chemical vapor deposition, etc.) and may include any suitable materials. The one or more redistribution lines 123 may be embedded (e.g., embedded traces) in the dielectric layer(s) 121, and may include, but are not limited to, metallic materials such as copper, titanium, nickel, gold, and combinations or alloys thereof. Further, routing layer 120 may include a passivation layer, such as passivation layer 125 (e.g., low temperature polyimide (“LTPI”), etc.) on the back side of routing layer 120, where the back side of routing layer 120 may also include under bump metallization (UBM) pads 127 and solder joints 129 that bond IC package structure 101 to module substrate 201 (e.g., surface mount technology).

Still referring to FIGS. 1A-1B, electronic component 110 may be directly bonded to routing layer 120. Direct bonding may be accomplished using suitable techniques, such as fusion bonding (e.g., dielectric-dielectric bonds) or hybrid bonding (e.g., metal-metal bonds and dielectric-dielectric bonds), where the dielectric materials used by hybrid and/or fusion bonding can be inorganic-based or organic-based materials. In the example of FIGS. 1A-1C, electronic component 110 may include planar bonding surface 112, a plurality of metal bond pads 114, and dielectric bonding layer 116 on BEOL build-up structure 118. Similarly, routing layer 120 may include bonding surface 122, metal bond pads 124 and dielectric bonding layer 126. Dielectric bonding layers 116, 126 may be an insulating material, such as an oxide (e.g., silicon oxide, silicon nitride, silicon carbon nitride, etc.). Further, bonding surfaces 112, 122 may be planarized (e.g., chemical mechanical polishing (CMP)) to facilitate fusion or hybrid bonding, where such planarized bonding surfaces may be directly bonded to one another at (and diffused across) a bonding interface.

It should be noted that while FIGS. 1A-1C illustrate electronic component 110 directly bonded to routing layer 120 (e.g., hybrid bonding, etc.), it is contemplated that electronic component 110 may be bonded to routing layer 120 by other methods (e.g., flip-chip bonding, etc.). For example, in some embodiments, IC package structure 101 may be packaged according to a “chip first” approach in which IC dies are diced and encapsulated within a gap fill material (e.g., gap fill material 130) to form a reconstituted wafer or panel, where a routing layer (e.g., routing layer 120) may then be formed on the reconstituted wafer to create a direct electrical connection between the die bond pads of the IC dies and the embedded traces (e.g., one or more redistribution lines 123) of the routing layer. In other embodiments, IC package structure 101 may be packaged according to a “chip last” approach in which IC dies are bumped and bonded to a routing layer (e.g., routing layer 120) and then encapsulated with a gap fill material (e.g., gap fill material 130), where such embodiments may include an optional underfill between the IC dies and routing layer. In other embodiments still, electronic component 110 may be a package (or multiple packages) bonded to routing layer 120 by any suitable method (e.g., surface mount technology, flip chip bonding, etc.) and then encapsulated by gap fill material 130 to form a package-in-package (PiP) structure.

In further reference to FIGS. 1A-1C, electronic module 100 may also include antenna 150. Antenna 150 may enable communication between any number of devices (e.g., wearable devices, mobile devices, tablets, etc.) by converting radio waves to electric current (e.g., reception) and/or electric current into radio waves (e.g., transmission), where antenna 150 may be configured to operate at any frequency range (e.g., 2.4 GHz, 5GHz etc.). In addition, antenna 150 may be attached (e.g., laminated, etc.) to one or more surfaces of IC package structure 101 (e.g., top surface, bottom surface, side surface, top and side surface, etc.). In an embodiment, antenna 150 may be attached to top surface 102A of IC package structure 101, as illustrated in FIG. 1A. In another embodiment, antenna 150 may be attached to bottom surface 102B of IC package structure 101, as illustrated in FIG. 1B. In another embodiment still, antenna 150 may be attached to multiple surfaces. For example, antenna 150 may be attached to both top surface 102A and side surface 102C of IC package structure 101, as illustrated in FIG. 1C, although other combinations/attachments to the multiple surfaces of IC package structure 101 are contemplated. In such instances, antenna 150 may bend/conform to the shape of IC package structure 101. Further, where antenna 150 attaches to the side of the IC package structure (e.g., side surface 102C), antenna 150 may extend to routing layer 120 and electrically connect to routing layer 120 through the one or more redistribution lines 123 embedded in dielectric layers 121 along the side surface.

Referring to FIG. 1A and FIG. 1C, electronic module 100 may include vertical interconnects to connect the antenna to the routing layer. The vertical interconnects may be formed of any suitable conductive material to facilitate an electrical connection between the antenna and the routing layer. In embodiments, the vertical interconnects may include plated pillars, pins, through mold vias, through oxide vias, PCB bars, laser direct structuring vias, etc., which may extend from routing layer 120 to one or more surfaces of IC package structure 101. In some embodiments, the vertical interconnect may extend to the top surface of the IC package structure. For example, as illustrated in FIG. 1A and FIG. 1C, vertical interconnect 140 extends through a thickness of gap fill material 130 from routing layer 120 to top surface 102A of IC package structure 101, where vertical interconnect 140 connects to antenna 150 through interconnect 142 (e.g., solder joint, silver epoxy, conductive paste or tape, etc.). In other embodiments, vertical interconnect 140 may extend through another surface of IC package structure 101, such as side surface 102C.

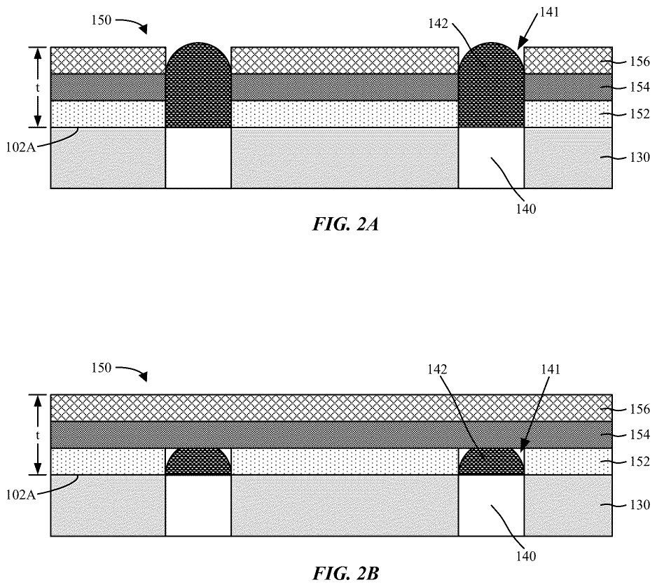

Referring now to FIGS. 2A-2B, FIG. 2A is a close-up view of an antenna that includes a through hole that extends through an entire thickness of the antenna in accordance with embodiments; FIG. 2B is a close-up view of an antenna that includes a through hole that extends through a partial thickness of the antenna in accordance with embodiments. As shown in FIG. 2A, antenna 150 may include an adhesive insulation layer 152, a patterned metal antenna layer 154 and a protective layer 156, where the layers may be formed using any suitable process, such as a lamination process. For example, in a lamination process, each layer may be rolled out in a “top to bottom” approach (protective layer 156 rolled out first, followed by patterned metal antenna layer 154 and adhesive insulation layer 152, respectively) or a “bottom to top” approach (adhesive insulation layer 152 rolled out first, followed by patterned metal antenna layer 154 and adhesive insulation layer 152, respectively), where heat and pressure may be applied during the lamination process to ensure good contact between layers. Further, the patterns of each layer of antenna 150 may be formed before or after the lamination process.

In further reference to FIGS. 2A-2B, adhesive insulation layer 152 may include any suitable adhesive (e.g., pressure sensitive adhesive, temperature sensitive adhesive, etc.) to attach antenna 150 to one or more surfaces of IC package structure 101. In such instances, adhesive insulation layer 152 may be selectively applied to non-connection areas so that the connection areas remain exposed for soldering. In the embodiment shown in FIG. 2A, adhesive insulation layer 152 attaches antenna 150 to top surface 102A of IC package structure 101. In other embodiments, adhesive insulation layer 152 may attach antenna 150 to multiple surfaces of IC package structure 101, as illustrated in FIG. 1C. In this way, when attaching the antenna to an IC package structure, the antenna may bend at one or more locations to conform its shape to the shape of the IC package structure or any another device upon which the antenna may be attached. Patterned metal antenna layer 154 may be any suitable conductive material (e.g., Cu, Al, etc.) for receiving and transmitting signals. The patterned metal antenna layer may be formed by any suitable method, such as die cutting from metal tapes and laser cutting. In this way, the patterned metal antenna layer may be formed in a cost effective manner by which new designs may be implemented efficiently relative to conventional methods. Protective layer 156 may be formed over patterned metal antenna layer 154 and may be any suitable material to prevent oxidation of the patterned metal antenna layer. In addition, the thickness of antenna 150 may be in the micron range. In one embodiment, antenna 150 has a thickness, t, that ranges from 2-20 microns.

Still referring to FIGS. 2A-2B, the antenna may include a through hole to facilitate an electrical connection between the patterned metal antenna layer of the antenna and the routing layer. In some embodiments, the through hole may extend through an entire thickness of the antenna. For example, in reference to FIG. 2A, through hole 141 may extend through an entire thickness of antenna 150, where through hole 141 extends from top surface 102A of IC package structure 101 and through protective layer 156 of antenna 150. In other embodiments, the through hole may extend through a partial thickness of the antenna. For example, in reference to FIG. 2B, through hole 141 may extend through a partial thickness of antenna 150, where through hole 141 extends from top surface 102A of IC package structure 101 and through adhesive insulation layer 152 to expose a portion of patterned metal antenna layer 154. Further, the electrical connection between the patterned metal antenna layer and the module substrate may be formed by any suitable process such as direct soldering, hot bar process, laser solder jetting, silver epoxy or conductive paste dispensing, etc. For example, in FIGS. 2A-2B, interconnect 142 (e.g., solder joint, silver epoxy, conductive paste or tape, etc.) may be formed in through hole 141, where interconnect 142 electrically connects the exposed portion of patterned metal antenna layer 154 to vertical interconnect 140 and ultimately to routing layer 120.

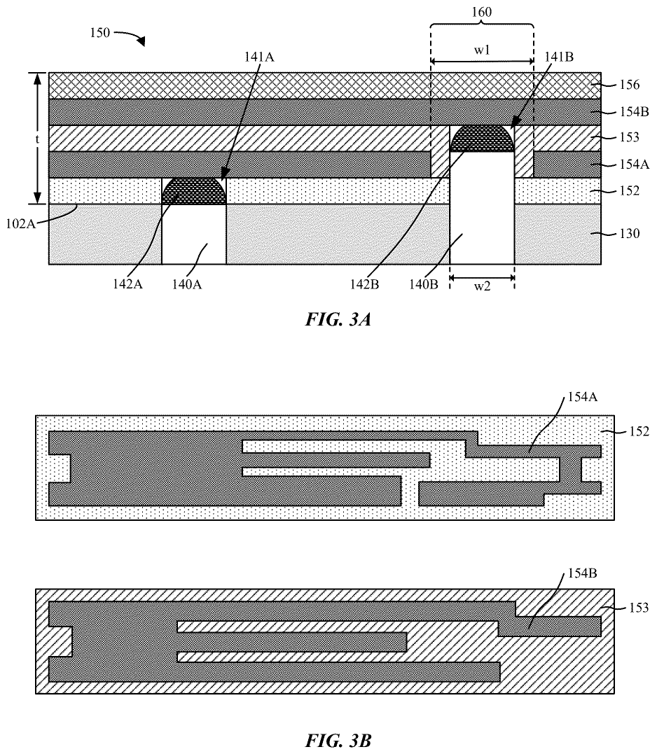

Referring now to FIGS. 3A-3B, FIG. 3A is a close-up view of an antenna that includes multiple patterned metal antenna layers in accordance with embodiments; FIG. 3B is a top view of an antenna in accordance with embodiments. In some embodiments, antenna 150 may include multiple patterned metal antenna layers. For example, as shown in FIG. 3A, antenna 150 may include a first patterned metal antenna layer 154A and a second patterned metal antenna layer 154B. In such instances, a dielectric layer (e.g., dielectric layer 153) may be located between the multiple patterned metal antenna layers to eliminate or at least reduce any interference between the respective signals associated with each metal pattern layer. Similar to FIGS. 2A-2B, an antenna with multiple patterned metal antenna layers may use through holes to facilitate an electrical connection between each respective patterned metal antenna layer and the routing layer. For example, as illustrated in FIG. 3A, through hole 141A may extend through a partial thickness of antenna 150, where through hole 141A extends from top surface 102A of IC package structure 101 through adhesive insulation layer 152 to expose a portion of first patterned metal antenna layer 154A. Further, the electrical connection between each of the patterned metal antenna layers and the routing layer may be formed by any suitable process such as direct soldering, hot bar process, laser solder jetting, silver epoxy or conductive paste dispensing, conductive taping, etc., similar to the embodiments described in FIGS. 2A-2B. For example, in FIG. 3A, interconnect 142A (e.g., solder joint, silver epoxy, conductive paste or tape, etc.) may be formed in through hole 141A, where interconnect 142A electrically connects to the exposed portion of first patterned metal antenna layer 154A and ultimately to routing layer 120 through vertical interconnect 140A.

In further reference to FIG. 3A, antennas that include multiple patterned metal antenna layers may be structured so that each patterned metal antenna layer maintains its own separate electrical connection to the routing layer. In such instances, each patterned metal antenna layer and/or its surrounding layer may be pre-patterned before the lamination process or patterned after the lamination to facilitate the separate electrical connections. In an embodiment, the width of an opening in a first patterned metal antenna layer may be greater than the width of the vertical interconnect that electrically connects to a second patterned metal antenna layer. Further, a surrounding layer above and/or below each patterned metal antenna layer (e.g., dielectric layer, adhesive insulation layer, etc.) may at least partially fill or occupy any voids/gaps created by the opening. In this way, the surrounding layer(s) insulate the patterned metal antenna layers and prevent one patterned metal antenna layer (e.g., first patterned metal antenna layer 154A) from electrically connecting the vertical interconnect of another patterned metal antenna layer (e.g., second patterned metal antenna layer 154B). For example, as illustrated in FIG. 3A, through hole 141B extends through a partial thickness of antenna 150, where through hole 141B extends from top surface 102A of IC package structure 101 through adhesive insulation layer 152 and dielectric layer 153 to expose a portion of second patterned metal antenna layer 154B. In addition, the width, w1, of opening 160 in first patterned metal antenna layer 154A is greater than the width, w2, of second vertical interconnect 140B so that first patterned metal antenna layer 154A does not form an electrical connection with second vertical interconnect 140B. In some embodiments, such as the embodiment shown in FIG. 3A, dielectric layer 153 fills or occupies the void between first patterned metal antenna layer 154A and second vertical interconnect 140B created by opening 160. In other embodiments, different layers, such as adhesive insulation layer 152, may fill or occupy the void between first patterned metal antenna layer 154A and second vertical interconnect 140B.

Still referring to FIG. 3A, the electrical connection between each of the patterned metal antenna layers and the routing layer may similarly be formed by any suitable process such as direct soldering, hot bar process, laser solder jetting, silver epoxy or conductive paste dispensing, conductive tape, etc. For example, interconnect 142B (e.g., solder joint, silver epoxy, conductive paste or tape, etc.) may be formed in through hole 141B, where interconnect 142B electrically connects to an exposed portion of second patterned metal antenna layer 154B and ultimately to routing layer 120 through second vertical interconnect 140B. Further, each of the patterned metal antenna layers in the multiple patterned metal antenna layers may be different from each other. For example, as illustrated in FIG. 3B, the pattern of first patterned metal antenna layer 154A is different from the pattern of second patterned metal antenna layer 154B. In this way, antenna 150 may include multiple patterned metal antenna layers and therefore may include multiple types of functionalities within the same antenna, as opposed to conventional methods in which multiple separate antennas may be required.

In utilizing the various aspects of the embodiments, it would become apparent to one skilled in the art that combinations or variations of the above embodiments are possible for forming an electronic module that includes an antenna. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. An electronic module comprising:
a module substrate;
an integrated circuit (IC) package structure mounted to the module substrate, the IC package structure including a routing layer, an electronic component bonded to the routing layer, and a gap fill material that encapsulates the electronic component; and
an antenna attached to the IC package structure, the antenna including an adhesive insulation layer, a patterned metal antenna layer over the adhesive insulation layer and a protective layer over the patterned metal antenna layer, wherein the patterned metal antenna layer is electrically connected to the routing layer.

2. The electronic module of claim 1, wherein the antenna includes multiple patterned metal antenna layers, the multiple patterned metal antenna layers including a first patterned metal antenna layer with a first pattern and a second patterned metal antenna layer with a second pattern, the first pattern being different from the second pattern.

3. The electronic module of claim 2, wherein a dielectric layer is located between the first patterned metal antenna layer and the second patterned metal antenna layer.

4. The electronic module of claim 2, wherein the first patterned metal antenna layer connects to the routing layer through a first interconnect that connects the first patterned metal antenna layer to a first vertical interconnect, the first vertical interconnect extending through a thickness of the gap fill material to the routing layer.

5. The electronic module of claim 2, wherein the second patterned metal antenna layer connects to the routing layer through a second interconnect that connects the second patterned metal antenna layer to a second vertical interconnect, the second vertical interconnect extending through a thickness of the gap fill material to the routing layer.

6. The electronic module of claim 5, wherein a first width of an opening in the first patterned metal antenna layer is greater than a second width of the second vertical interconnect.

7. The electronic module of claim 6, wherein a surrounding layer at least partially occupies the opening to prevent electrical contact between the first patterned metal antenna layer and the second vertical interconnect.

8. The electronic module of claim 7, wherein the surrounding layer is a dielectric layer.

9. The electronic module of claim 7, wherein the surrounding layer is the adhesive insulation layer.

10. The electronic module of claim 1, wherein the antenna attaches to multiple surfaces of the IC package structure.

11. The electronic module of claim 1, wherein the antenna conforms to a shape of the IC package structure and connects to a side of the routing layer.

12. An antenna comprising:
an adhesive insulation layer;
a first patterned metal antenna layer over the adhesive insulation layer;
a protective layer over the first patterned metal antenna layer; and
a first through hole that extends through the adhesive insulation layer and exposes a portion of the first patterned metal antenna layer.

13. The antenna of claim 12, wherein the antenna includes multiple patterned metal antenna layers, the multiple patterned metal antenna layers including the first patterned metal antenna layer with a first pattern and a second patterned metal antenna layer with a second pattern, the first pattern being different from the second pattern.

14. The antenna of claim 13, wherein a dielectric layer is located between the first patterned metal antenna layer and the second patterned metal antenna layer.

15. The antenna of claim 13, wherein the first patterned metal antenna layer connects to a first interconnect, the first interconnect electrically connecting the first patterned metal antenna layer to a first vertical interconnect.

16. The antenna of claim 13, wherein the second patterned metal antenna layer connects to a second interconnect, the second interconnect electrically connecting the second patterned metal antenna layer to a second vertical interconnect.

17. The antenna of claim 16, wherein a first width of an opening in the first patterned metal antenna layer is greater than a second width of the second vertical interconnect.

18. The antenna of claim 17, where a surrounding layer at least partially occupies the opening to prevent electrical contact between the first patterned metal antenna layer and the second vertical interconnect.

19. The antenna of claim 18, wherein the surrounding layer is a dielectric layer.

20. The antenna of claim 18, wherein the surrounding layer is the adhesive insulation layer.
